(19) United States
(12) Patent Application Publication
(10) Pub. No.: US 2010/0157083 A1
(43) Pub. Date: Jun. 24, 2010

(54) IMAGING SYSTEM

(75) Inventors: Takeru Ohya, Machida-shi (JP); Kazuyuki Shigeta, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/610,405

(22) Filed: Nov. 2, 2009

(30) Foreign Application Priority Data
Dec. 19, 2008 (JP) 2008-324707

(51) Int. Cl. H04N 5/228; H04N 5/335; H04N 5/225

(52) U.S. Cl. 348/222.1; 348/302; 348/340; 348/E05.091; 348/E05.031; 348/E05.024

(57) ABSTRACT

An imaging system comprises: a pixel array; a vertical shift register; a readout unit; and a horizontal shift register, wherein the vertical shift register, when signals of some rows of all rows in the pixel array are read out to the readout unit, starts shift operation for skip scanning of the signals of non-readout rows before an operation to scan the readout unit by the horizontal shift register in a direction along a row is completed, and executes selection scanning of readout rows such that the signals are read out to the readout unit from the readout row selectively scanned by the vertical shift register after the operation to scan the readout unit by the horizontal shift register in the direction along the row is completed.

### BACKGROUND OF THE INVENTION

1. Field of the Invention

The present invention relates to an imaging system.

2. Description of the Related Art

In the specification of Japanese Patent Laid-Open No. 2005-86245, as shown in FIG. 5 and FIG. 6 thereof, a method of alternately repeating, by the frame, a readout operation of a sub-sampled signal from all columns of 1^{st}, 4^{th} and 7^{th} rows and a readout operation of a continuous signal of the central portion from 7^{th}-12^{th} columns of 1^{st}, 4^{th} and 7^{th} rows without sub-sampling is disclosed. According to the specification of Japanese Patent Laid-Open No. 2005-86245, the sub-sampled signal for image display and a continuous signal of the central portion for AF (Auto Focus) are obtained while increasing the frame rate.

In the specification of Japanese Patent Laid-Open No. 2005-86245, as shown in FIG. 7 thereof, in the frame in which the continuous signal of the central portion is read out, a horizontal blanking period for row number 4 is started after a predetermined period of time has elapsed after reading out of the pixel signal of the row number 1 is completed. During this predetermined period, it is considered that the vertical scanning circuit perform operations to advance the row number from 1 to 4. In this case, it takes a time to read out the signal from the pixel array to an output channel.

### SUMMARY OF THE INVENTION

The present invention provides for speeding up the reading operation of the signal from the pixel array.

According to a first aspect of the present invention, there is provided an imaging system comprising: a pixel array in which a plurality of pixels are arranged in a direction along a row and in a direction along a column; a vertical shift register for scanning the pixel array in the direction along the column to read out signals from the pixel array by shift operation; a readout unit for holding the signals read out from the pixel array; and a horizontal shift register for scanning the readout unit in the direction along the row by shift operation, wherein the vertical shift register, when the signals of some rows of all rows in the pixel array are read out to the readout unit, starts the shift operation for skip scanning of the signals of non-readout rows before the operation to scan the readout unit by the horizontal shift register in the direction along the row is completed, and executes selection scanning of readout rows such that the signals are read out to the readout unit from the readout row selectively scanned by the vertical shift register after the operation to scan the readout unit by the horizontal shift register in the direction along the row is completed.

According to a second aspect of the present invention, there is provided an imaging system comprising: a pixel array in which a plurality of pixels are arranged in a directions along a row and in a direction along a column; a vertical shift register for scanning the pixel array in the direction along the column to read out signals from the pixel array by shift operation; a readout unit for holding the signals read out from the pixel array; a horizontal shift register for scanning the readout unit in the direction along the row by shift operation; and an output unit for outputting the signal transferred from the readout unit, wherein the horizontal shift register, when the signals of some columns among the signals of all columns of the row read out from the pixel array to the readout unit is transferred to the output unit, starts the shift operation for skip scanning of the signals of the non-transfer columns before the operation to read out the signal from the readout row to the readout unit is completed, and executes selection scanning of the signals of the transfer columns in the readout unit such that the signal of the transfer columns in the readout unit selectively scanned by the horizontal shift register after the operation to read out the signals from the readout row to the readout unit is completed.

According to a third aspect of the present invention, there is provided an imaging system according to the first or second aspect of the present invention further comprising: an optical system for forming an image on the pixel array; and a signal processing unit for processing the signal output via the readout unit to generate the image data.

According to the present invention, the speed of reading out operation for reading out the signal from the pixel array can be improved.

Further features of the present invention will become apparent from the following description of exemplary embodiments with reference to the attached drawings.

### BRIEF DESCRIPTION OF THE DRAWINGS

FIG. 1 illustrates a configuration of an imaging system 100 according to the first embodiment of the present invention.

FIG. 2 illustrates the relationship between the image captured by the imaging system according to the embodiment of the present invention and the pixel of the pixel array from which the image signal is obtained.

FIGS. 3A to 3C illustrate a timing chart showing the operation of the image sensor 120 according to the first embodiment of the present invention.

FIG. 4 illustrates a timing chart showing the operation of the image sensor 120 according to the second embodiment of the present invention.

FIG. 5 illustrates a timing chart showing the operation of the image sensor 120 according to the third embodiment of the present invention.

FIG. 6 illustrates a problem to be solved by the present invention.

FIG. 7 illustrates a problem to be solved by the present invention.

FIG. 8 illustrates a problem to be solved by the present invention.

### DESCRIPTION OF THE EMBODIMENT

At first, a problem to be solved by the present invention will be explained in detail with reference to the drawings.

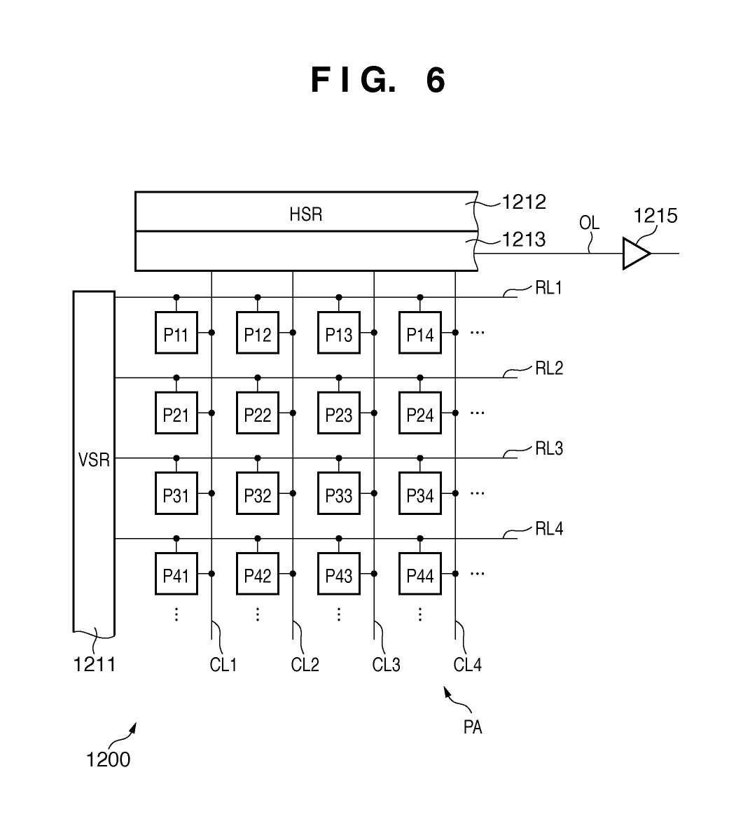

FIG. 6 illustrates the configuration of the image sensor 1200.

The image sensor 1200 is, for example a CMOS sensor. The image sensor 1200 comprises a pixel array PA, a vertical shift register (VSR) 1211, a horizontal shift register (HSR) 1212 and an output unit 1215.

In the pixel array PA, a plurality of pixels (P11-P44) are arranged in a direction along a row and a direction along a column (i.e. in XY matrix). Among the plurality of pixels (P11-P44), pixels in the same row are connected to the same row control line (one of RL1-RL4) and pixels in the same column are connected to the same column control line (one of CL1-CL4). Each of pixels generates the signal corresponding to the incident light by performing a charge accumulation operation during a predetermined accumulation period.

The vertical shift register 1211 selects the rows (readout rows) by scanning the pixel array PA in the direction along a column during a vertical scanning period VSCAN. The vertical shift register 1211, for example, executes an operation for shifting according to an input of external pulse. The vertical shift register 1211 selects a row from which the signal is read out by applying an active selection control signal to the row control line corresponding to the rows of the pixel array to be selected.

The readout unit 1213 holds the signal read out through the column signal lines CL1-CL4 from the selected row selected by the vertical shift register 1211 during the vertical blanking period (HBLK).

The horizontal shift register 1212 transfers the signals of columns (signals of transfer columns) in the signals of the row held in the readout unit 1213 to the output unit 1215 through the output line OL by scanning the readout unit 1213 in the direction along a row during the horizontal scanning period HSCAN. The horizontal shift register, for example, executes the shift operation of the column to be selected by an external pulse.

The output unit 1215 is, for example, an output amplifier and generates and outputs an image signal based on the signal received through the output line OL.

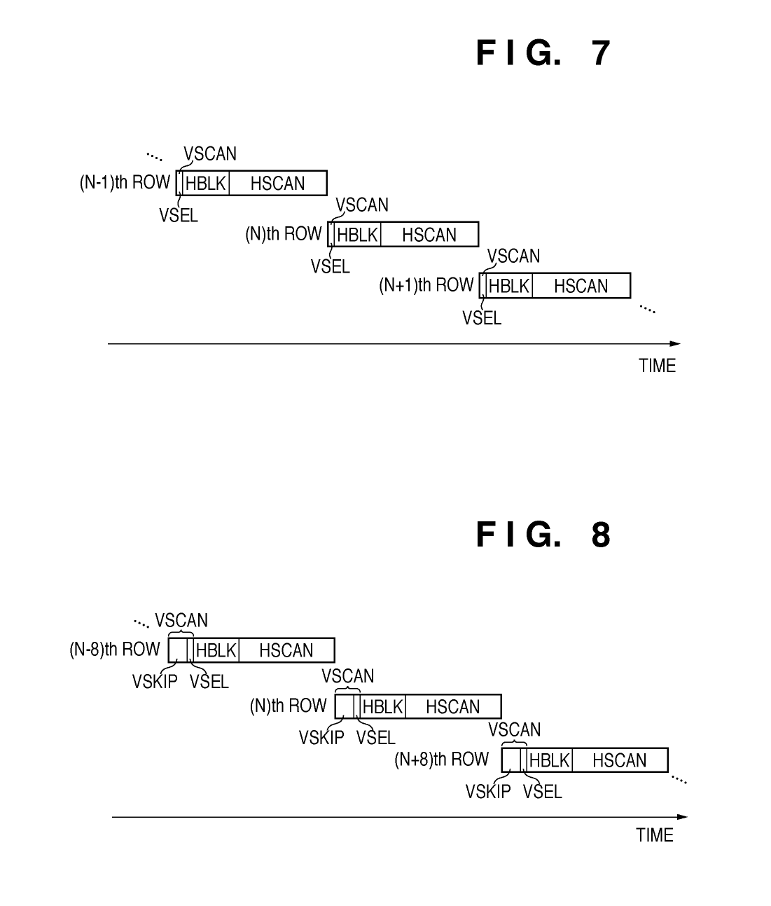

FIG. 7 illustrates an example of a timing chart of the image sensor showing the case where the signal is read out from all pixels of the pixel array without sub-sampling or partial readout.

The pixel array of the image sensor is basically driven by the row. For example, the method of driving of pixels of the pixel array will be explained with a central focus on the (N)th row.

After the completion of the horizontal transferring operation of the (N−1)th row, the operation of scanning of the (N)th row is executed. That is, after the HSCAN period of the (N−1)th row is completed, the VSCAN period of the (N)th row is started. In the VSCAN period, the vertical shift register 1211 advances the row number by one and generates the selection control signal. The period during which the row number is advanced and the selection control signal is generated is called VSEL in FIG. 7.

In the HBLK period, the vertical shift register 1211 reads out the signal of pixels in the (N)th row on the block by applying the generated selection control signal to the pixels in the (N)th row. After that in the HSCAN period, the horizontal shift register 1212 advances the column number to be selected one-by-one and the signal of each column is read out sequentially from the readout unit to the output unit.

FIG. 8 illustrates an example of an operation timing of the image sensor when the signals are read out from the pixel array by sub-sampling and with low resolution.

When the signals are read out from the pixel array by sub-sampling, the number of times the vertical shift register advances the row number to be selected in the row scanning (VSCAN) operation is increased. FIG. 8 shows the example in which the signal is read out by sub-sampling one row every 8 rows. In this case, the vertical shift register 1211 advances the row number to be selected 8-fold in the row scanning operation (VSCAN). For this reason, the time required for the row scanning operation is longer than the case where all pixels are read out. The period of skip scanning during which the row number is advanced and the selection control signal is not generated is called VSKIP in FIG. 8. That is, the vertical shift register executes the selection scanning VSEL of readout rows after the skip scanning VSKIP of non-readout rows in the vertical scanning period VSCAN completes.

If it is simply imagined from the operation timings when signals are read out from whole pixels, the operation timings when signal is sub-sampled as shown in FIG. 8. That is, after the HSCAN period of the predetermined readout row (e.g. the (N−8)th row) is completed, processing of the vertical shift register is moved to the scanning (VSCAN) operation of the next readout row (e.g. the (N)th row).

In this case, it takes a long time to read out the signal from the pixel array PA to the output unit 1215. For example, it is assumed that the period of VSKIP in FIG. 8 is 8 μs. If it is assumed that 500 rows are read out totally with one row being sub-sampled per 8 rows, it takes 4 ms for every one frame for the VSKIP period during which the signal is not read out.

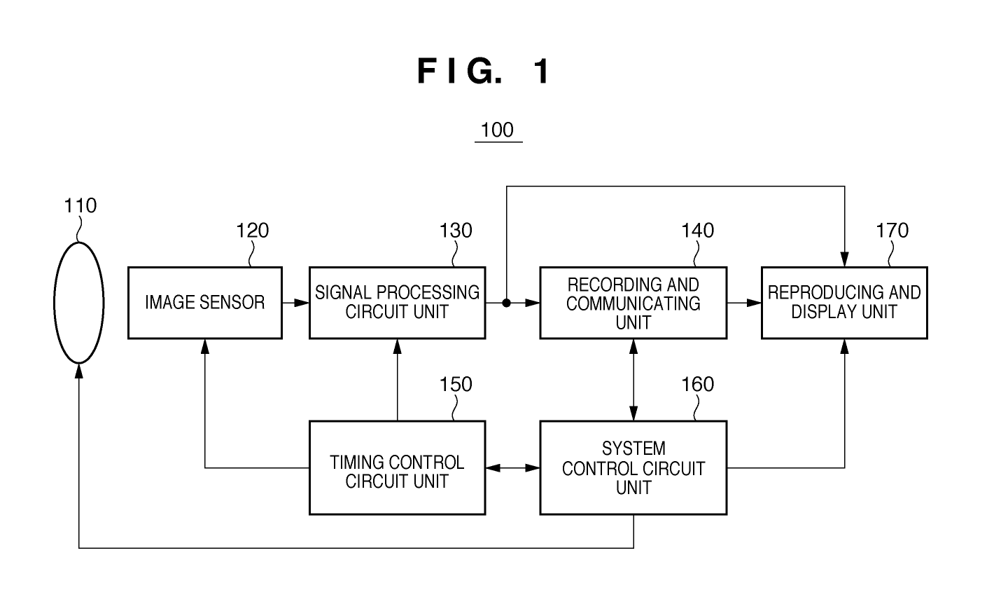

Next, the imaging system 100 according to the first embodiment of the present invention will be explained with reference to FIG. 1. FIG. 1 illustrates the configuration of the imaging system 100 according to the first embodiment of the present invention. Hereinafter, as the operation mode of the imaging system 100, an example of the operation mode in which the total image by sub-sampling and the partial image with high resolution are alternately obtained. However, the operation mode of the imaging system 100 is not limited to this, but may include, for example, the operation mode in which only a sub-sampled image is obtained or only a partial image is obtained.

The imaging system comprises an optical system 110, an image sensor 120, a signal processing circuit unit (a signal processing unit) 130, a recording and communicating unit 140, a timing control circuit unit 150, a system control circuit unit 160 and a reproducing and a display unit 170.

The object light irradiated through the optical system 110 is imaged on the image sensing plane of the image sensor 120. That is, the optical system 110 forms an image of the object on the imaging plane (pixel array) of the image sensor 120.

The image sensor 120 converts the image of the object formed on the pixel array to an image signal (analog signal) and outputs the converted image signal. Although the image sensor 120 has basically similar configuration to the image sensor 1200 shown in FIG. 6, the image sensor 120 performs different operations from that of the image sensor 1200 as below. The operation of the image sensor 120 will be specifically explained hereinafter.

The signal processing circuit 130 receives the image signal (analog signal) output from the image sensor 120. The signal processing circuit 130 generates the imaging data by a signal conversion process to the received image signal according to the predetermined method. The signal processing circuit supplies the generated image data to the recording and communicating unit 140 or reproducing and display unit 170.

The recording and communicating unit 140 converts the received image data to the image data for recording (for example, compressed image data), and records it on the recording media. Alternatively, the recording and communicating unit 140 converts the received image data to the image data (for example, the serial data) for transmitting, and transmits it to the external apparatus. The recording and communicating unit 140 reads out the image data for reproducing from the recording media and supplies it to the reproducing and display unit 170.

The reproducing and display unit 170 converts the received image data to the image data for reproducing and display (for example, NTSC analog signal), and supplies it to the display device (for example, LCD). By this operation, the display device displays the image corresponding to the image signal for reproduction and display.

The timing control circuit 150 controls the driving timing for the image sensor 120 and the signal processing circuit 130 based on the control by the system control circuit unit 160.

The system control circuit unit 160 controls each unit in the imaging system 100 in a comprehensive manner. The system control circuit unit 160, for example controls the respective units of the optical system 110, the recording and communicating unit 140, timing control circuit unit 150 and the reproducing and display unit 170. Further, the system control circuit unit 160 controls drivings of the image sensor 120 and the signal processing circuit unit 130 through the timing control circuit unit 150.

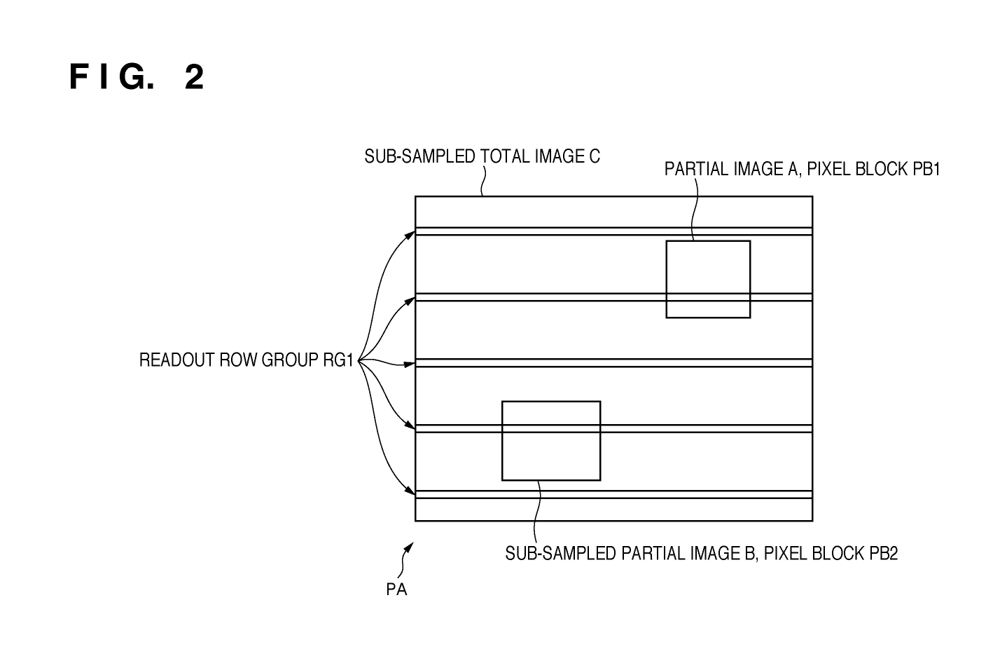

FIG. 2 illustrates the relationship between the image captured by the imaging system 100 according to the present embodiment of the present invention and the pixels of the pixel array from which the image signal is obtained.

As shown in FIG. 2, sub-sampled total image C is formed from the pixels sub-sampled from the pixel array PA of the image sensor 120, that is, formed based on the signal read out from the readout row group RG1. Here, the total image has a low resolution as it is read out from total pixel array by sub-sampling. The system control circuit unit 160 executes a recording control operation and a monitoring operation in response to the signal of the total image received from the image sensor 120, and as a result of that, a pixel region of interest is determined.

The system control circuit unit 160, for example, determines the pixel block PB1 as the pixel region of interest. In response to this, the image sensor 120 reads out the signal from the pixel block PB1 with high pixel density and outputs it. The system control circuit unit 160 obtains the partial image A with high resolution by processing the signal output from the image sensor 120.

The system control circuit unit 160, for example, determines the pixel block PB2 as the pixel region of interest. In response to this, the image sensor 120 reads out the signal from the pixel block PB2 with low pixel density and outputs it. The system control circuit unit 160 obtains the sub-sampled partial image B by processing the signal output from the image sensor 120.

It should be noted that, although the above example explains a case in which one vertical shift register and one horizontal shift register are used, the present embodiment can be applied to a case in which the system includes two or more vertical shift registers and horizontal shift registers so that the freedom of selection can be high, when a pixel selection operation, a transfer operation to the memory in the readout unit 1213, or a readout operation from the memory is executed. Alternatively, although the above example explains a case in which one readout unit 1213 for one row is arranged in one location, the present embodiment can be applied to a case in which the readout unit is divided into two locations or has the memory capacity of two rows.

The present embodiment can be applied in the imaging system in which all or some of signal processing circuit unit 130, recording and communication unit 140, timing control circuit unit 150 and the system control circuit unit 160 are fabricated on the same chip as the image sensor 120.

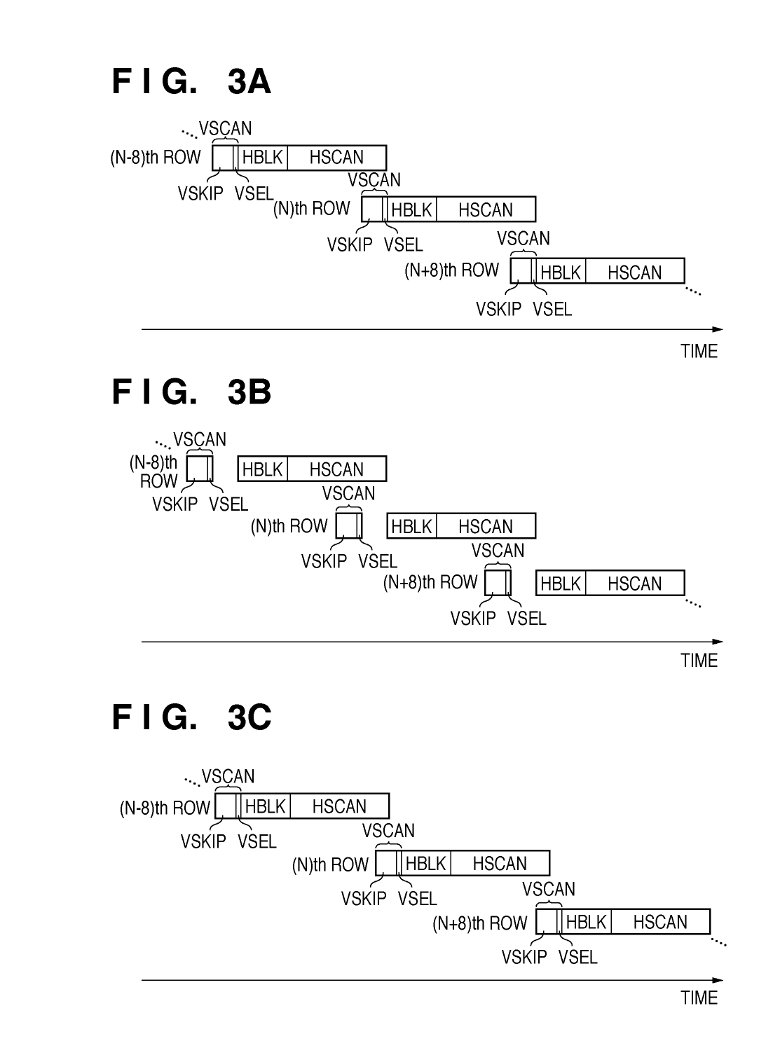

Next, the operation of the imaging system 100 (referring to FIG. 1) according to the first embodiment of the present invention will be explained with reference to FIGS. 3A to 3C and FIG. 6. FIGS. 3A to 3C are timing charts showing the operation of the image sensor according to the first embodiment of the present invention. Although FIG. 6 illustrates the configuration of the image sensor 1200, since the image sensor 120 has a basically similar configuration to that of the image sensor 1200, FIG. 6 can be diverted to the structural chart for the image sensor 120.

In each of FIGS. 3A to 3C, an example in which the signal from the pixel array PA is read out by sub-sampling with a period of sub-sampling one row per every 8 rows to obtain the sub-sampled total image C (FIG. 2) will be explained.

As shown in FIG. 3A, for example, the operation (HSCAN) to scan the readout unit 1213 in the direction along the row by the horizontal shift register and the operation (VSCAN) to scan the pixel array PA in the direction along the column are executed in parallel. By these operations, the image signal corresponding to the sub-sampled total image C is obtained. Concretely speaking, in the HSCAN period of the (N−8)th row, the horizontal shift register 1212 selects and transfers the respective column signal in the (N−8)th row held in the readout unit 1213 sequentially to the output unit 1215. While in the VSCAN period of the (N)th row, the vertical shift register 1211 executes the following operation after the skip operation (VSKIP) to advance the row number from N−8 to N−1 without generating the selection control signal. The vertical shift register 1211 executes the selection scanning operation (VSEL) to advance the row number from N−1 to N and to generate the selection control signal for the (N)th row.

That is, the operation of the imaging system 100 is different from that of the image sensor 1200 shown in FIG. 8 in the following respects. When the signals are read out from some rows of the pixel array, the following operation is executed in the image sensor 120 according to the present embodiment. In the image sensor 120, the operation (VSKIP) to scan the non-readout rows of the pixel array by the vertical shift register and the operation (HSCAN) to scan the readout unit in the direction along the row are executed in parallel. The vertical shift register starts scanning (VSKIP) the non-readout rows before the operation (HSCAN) to scan the readout unit in the direction along the row by the horizontal shift register is completed. The vertical shift register selects (VSEL) the next readout row in the pixel array before the operation (HSCAN) to scan the readout unit in the direction along the row is completed when the signals are read out from some rows of the pixel array. The readout unit reads out (HBLK) the signal from the next readout row after the operation (HSCAN) to scan the readout unit in the direction along the row by the horizontal shift register is completed.

By such operations, the time required to obtain the signal of one frame can be shortened than the example shown in FIG. 8 by the periods (VSKIP period+VSEL period X the number of rows). By this operation, speeding up of the operation to read out signal from the pixel array to the output unit can be realized.

It should be noted that, although the timing of the end of the HSCAN period of (N−8)th matches that of the end of VSCAN of the (N)th row (including VSKIP period and VSEL period) as shown in FIG. 3A, operations in the present embodiment are not limited to the operation described above, for example, the following operation may be executed.

For example, as shown in FIG. 3B, the VSCAN period of the (N)th row (including VSKIP period and VSEL period) may be started after the HSCAN period of the (N−8)th row is started, and may be completed before the HSCAN period of the (N)th row is completed.

Alternatively, as shown in FIG. 3C, the operation in which a part of the VSCAN period of the (N)th row (including the VSKIP period and VSEL period) overlaps the HSCAN period of the (N−8)th row may be used. That is, the VSCAN period of the (N)th row (including the VSKIP period and VSEL period) may be started after the HSCAN period of the (N−8)th row is started, and may be completed after the HSCAN period is completed. In this case, the time of (the overlapping time)×(the number of rows) can be shortened.

It should be also noted that, while the example to sub-sample one row per 8 rows is shown in the present embodiment, the rate of sub-sampling is an optional matter and the present embodiment can be applied to a case in which one row per 10 rows or one row per 16 rows is read out by sub-sampling.

Next, the operation according to the second embodiment of the present invention will be explained with reference to FIG. 4. FIG. 4 illustrates a timing chart showing the operation of the imaging system 100 according to the second embodiment of the present invention. The portion of the second embodiment different from the first embodiment will be mainly explained hereinafter.

In FIG. 4, an example in which the signal is read out from the pixel block PB1 of the pixel array without sub-sampling is explained.

As shown in FIG. 4, the operation to read out the signal from the pixel to the readout unit 1213 and the operation (HSCAN) to scan the readout unit 1213 in the direction along the row by the horizontal shift register are executed in parallel. By these operations, the image signal corresponding to the partial image A is obtained.

Specifically, firstly, the vertical shift register 1211 advances the row number to a number corresponding to the first row of the pixel block PB1 and the signal is started to be read out from the pixel in the row selected by the row number to the readout unit 1213. The signals of the columns to the left and right of the pixel block PB1 are not required, so the horizontal shift register 1212 skips signals of the columns to the left and right of the pixel block PB1 among the signals held in the readout unit 1213.

For example, the operation of the (N)th row included in the pixel block PB1 will be explained. The vertical shift register 1211 advances the row number from N−1 to N and generates the selection control signal for the (N)th row during the VSEL period in the VSCAN period of the (N)th row.

The vertical shift register 1211 supplies the selection control signal to the pixel of the (N)th row, and the signal is read out (HBLK) from the pixel of the (N)th row to the readout unit 1213.

Along with this operation, the horizontal shift register 1212 executes the skip scanning (HSKIP) to advance the column number to a number corresponding to the column adjacent to the left column of the pixel block PB1 without generating the horizontal scanning signal. The horizontal shift register 1212 advances the column number to a number corresponding to the leftmost column of the pixel block PB1 from a number corresponding to the column adjacent to the pixel block PB1 and executes the selection scanning (HSEL1) to generate the horizontal scanning signal.

The horizontal shift register 1212 executes selection scanning (HSEL2) to transfer the signal of the column to the output unit 1215 by supplying the horizontal scanning signal to the readout unit 1213 after the HBLK period is over. Thereafter, the horizontal shift register 1212 sequentially executes selection scanning (HSEL) corresponding to the selection scanning (HSEL1) and the selection scanning (HSEL2) as to the signal of respective column. Thus, as the horizontal shift register 1212 completes the selection of the desired column at the timing when the HBLK period is over, the transfer of the signal from the readout unit 1213 to the output unit 1215 can be started instantly.

That is, the operation of the imaging system 100 according to the present embodiment is different from that of the first embodiment in the following respects. The horizontal shift register starts scanning (HSKIP) the non-transfer columns before the operation (HBLK) to read out the signal from the selected column to the readout unit is completed, when the signal of some columns in the rows held in the readout unit is transferred to the output unit. In the image sensor 120 according to the present embodiment, the horizontal shift register transfers (HSEL2, HSEL) the signal of the transfer column to the output unit after the operation (HBLK) to read out the signal from the rows selected by the vertical shift register to the readout unit is completed. Further, the vertical shift register selects (VSEL) the next readout row of the pixel array before the operation (HSCAN) to scan the readout unit in the direction along the row by the horizontal shift register is completed, when the signal from some rows in the pixel array is read out to the readout unit.

By such operation, the time required to obtain the signal of one frame can be shortened relative to the embodiment shown in FIG. 8 by the periods (HSKIP period+HSEL1 period+VSEL period) X the number of rows. By this operation, speeding up of the operation to read out the signal from the pixel array to the output unit can be realized.

It should be noted that, while FIG. 4 shows that HSKIP is shorter than HBLK, it depends on the position of partial image and the time length of HBLK. The present embodiment can be applied to a case in which the time length of HBLK is shorter than HSKIP. Further, instead of matching the ending points or starting points of HBLK with that of HSKIP, the present embodiment can be modified such that a part of HBLK may be partially overlapped with HSKIP.

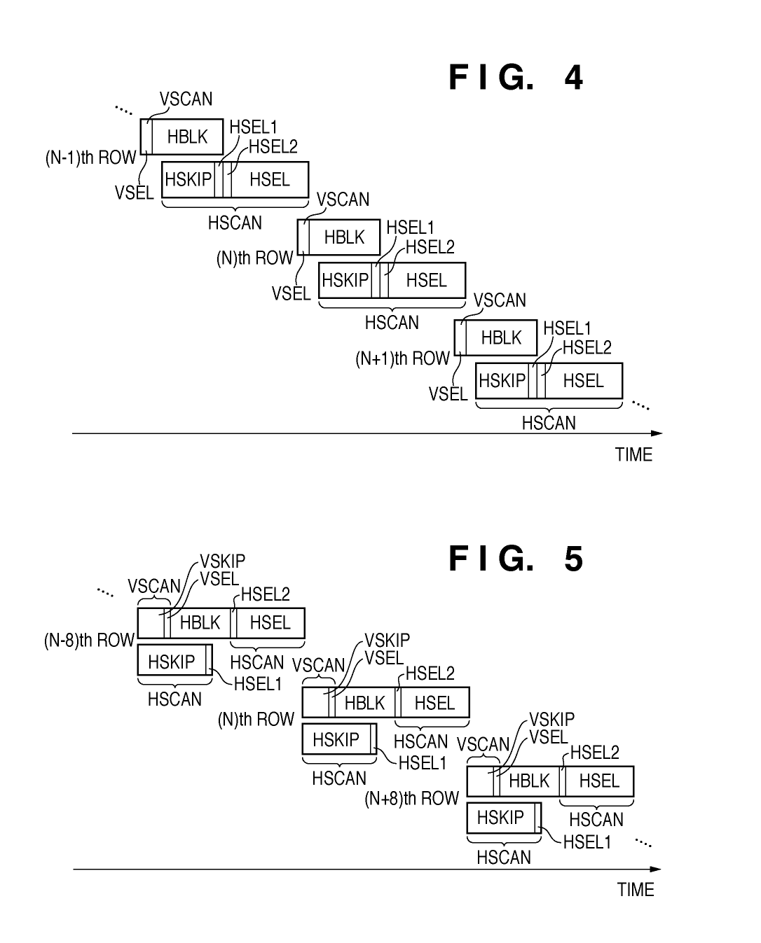

The operation of the imaging system 100 according to the third embodiment of the present invention will be explained with reference to FIG. 5. FIG. 5 is a timing chart showing the operation of the image sensor according to the third embodiment of the present invention. The portion of the present embodiment different from the first embodiment will be mainly explained hereinafter.

In FIG. 5, an example to read out the signal from the pixel block PB2 in the pixel array by sub-sampling to obtain the sub-sampled partial image B (with reference to FIG. 2) will be explained. In this case, sub-sampling with reading one row per 8 rows will be exemplified.

As shown in FIG. 5, the operation (HSCAN) to scan the readout unit 1213 in the direction along the row by the horizontal shift register 1212 and the operation (VSCAN) to scan the pixel array PA in the direction along the column by the vertical shift register are executed in parallel. By this operation, the image signal corresponding to the sub-sampled partial image B is obtained.

Specifically, after the completion of the HSCAN of the (N−8)th row, the vertical shift register 1211 executes the skip scanning (VSKIP) to advance the row number from N−8 to N−1 without generating the selection control signal. The vertical shift register 1211 generates the signal from the pixel of the (N)th row to the readout unit 1213 by supplying the selection control signal to the pixel of the (N)th row in the HBLK period.

In parallel with these operations (VSKIP, VSEL, HBLK), the horizontal shift register 1212 executes the skip scanning (HSKIP) of the signals of the non-transfer columns to advance the column number to a number corresponding to the column adjacent to the left of the pixel block PB2 without generating the horizontal scanning signal. Then, the horizontal shift register 1212 advances the column number to a number corresponding to the leftmost column of the pixel block PB2 from the number corresponding to the column adjacent to the left of the pixel block PB2 and executes the selection scanning (HSEL1) of the transfer column signal to generate the horizontal scanning signal.

That is, the difference between the operation of the imaging system 100 according to the present embodiment and that of the first embodiment is as follows. The vertical shift register starts scanning (VSKIP) of the non-readout rows after the operation (HSEL) to scan the readout unit in the direction along the row by the horizontal shift register is completed, when the signals are read out from some rows of the pixel array to the readout unit. The horizontal shift register scans (HSKIP) the non-transfer columns in the readout unit in parallel with the operation (VSKIP) to scan the non-readout rows by the vertical shift register, when the signal of some columns in the following readout row to be held in the readout unit is transferred to the output unit. The horizontal shift register transfers (HSEL2, HSEL) the transfer column signal after the operation (HBLK) to read out the signal from the following readout row to the readout unit is completed.

By such an operation, the time required to obtain the signal of one frame can be shortened relative to the example shown in FIG. 8 by (HSKIP period+HSEL1 period) X the number of rows. By this operation, speeding up of the operation to read out the signal from the pixel array to the output unit can be realized.

It should be noted that, although FIG. 5 shows an example, the present embodiment can be modified such that the relationship among time lengths of VSKIP, HSKIP, HBLK and HSCAN can differ case-by-case, and that the way of overlapping the operation periods in which the present embodiment is applied is not limited to this example.

While the present invention has been described with reference to exemplary embodiments, it is to be understood that the invention is not limited to the disclosed exemplary embodiments. The scope of the following claims is to be accorded the broadest interpretation so as encompass all such modifications and equivalent structures and function.

This application claims the benefit of Japanese Patent Application No. 2008-324707 filed Dec. 19, 2008 which is hereby incorporated by reference herein in its entirety.

What is claimed is:

1. An imaging system comprising:
a pixel array in which a plurality of pixels are arranged in a direction along a row and in a direction along a column;
a vertical shift register for scanning the pixel array in the direction along the column to read out signals from the pixel array by shift operation;
a readout unit for holding the signals read out from the pixel array; and
a horizontal shift register for scanning the readout unit in the direction along the row by shift operation,
wherein the vertical shift register, when the signals of some rows of all rows in the pixel array are read out to the readout unit, starts the shift operation for skip scanning of the signals of non-readout rows before the operation to scan the readout unit by the horizontal shift register in the direction along the row is completed, and executes selection scanning of readout rows such that the signals are read out to the readout unit from the readout row selectively scanned by the vertical shift register after the operation to scan the readout unit by the horizontal shift register in the direction along the row is completed.

2. An imaging system according to claim 1, further comprising an output unit for outputting the signal transferred from the readout unit, and
wherein the horizontal shift register, when the signals of some columns among the signals of all columns of the row read out from the pixel array are transferred to the output unit, starts the shift operation for skip scanning of the signals of non-transfer columns before the operation to read out the signals from the readout row to the readout unit is completed, and executes selection scanning of the signals of the transfer columns in the readout unit such that the signals of transfer columns selectively scanned by the horizontal shift register is transferred to the output unit after the operation to read out the signals from the readout row to the readout unit is completed.

3. An imaging system according to claim 1, further comprising an output unit for outputting the signal transferred from the readout unit, and
wherein the vertical shift register and the horizontal shift register, when the signals of some rows of all rows in the pixel array are read out to the output unit while the signals of some columns among the signals of all columns of the row read out from the pixel array are transferred to the output unit, start the shift operation for skip scanning of the non-readout rows and the shift operation for skip scanning of the signals of the non-transfer columns respectively, after the operation to scan the readout unit by the horizontal shift register in the direction along the row is completed,
thereafter the vertical shift register executes selection scanning of the readout rows such that the signal is read out from the readout row selectively scanned by the vertical shift register to the readout unit,
the horizontal shift register executes selection scanning of the signals of the transfer columns in the readout unit such that the signals of the transfer columns in the readout unit selectively scanned by the horizontal shift register are transferred to the output unit after the operation to read out the signal from the readout row to the readout unit is completed.

4. An imaging system comprising:
a pixel array in which a plurality of pixels are arranged in a directions along a row and in a direction along a column;
a vertical shift register for scanning the pixel array in the direction along the column to read out signals from the pixel array by shift operation;
a readout unit for holding the signals read out from the pixel array;
a horizontal shift register for scanning the readout unit in the direction along the row by shift operation; and
an output unit for outputting the signal transferred from the readout unit,
wherein the horizontal shift register, when the signals of some columns among the signals of all columns of the row read out from the pixel array to the readout unit is transferred to the output unit, starts the shift operation for skip scanning of the signals of the non-transfer columns before the operation to read out the signal from the readout row to the readout unit is completed, and executes selection scanning of the signals of the transfer columns in the readout unit such that the signal of the transfer columns in the readout unit selectively scanned by the horizontal shift register after the operation to read out the signals from the readout row to the readout unit is completed.

5. An imaging system according to claim 1 further comprising:
an optical system for forming an image on the pixel array; and
a signal processing unit for processing the signal output via the readout unit to generate the image data.

6. An imaging system according to claim 4 further comprising:
an optical system for forming an image on the pixel array; and
a signal processing unit for processing the signal output from the output unit to generate the image data.
